(19) United States
(12) Patent Application Publication
(10) Pub. No.: US 2014/0346396 A1
(43) Pub. Date: Nov. 27, 2014

(54) High Capacity Filter

(71) Applicant: HONEYWELL INTERNATIONAL, INC. - PATENT SERVICES M/S AB/2B, Morristown, NJ (US)

(72) Inventors: PETER M. MICHALAKOS, Arlington Heights, IL (US); MARK KOCH, Mount Prospect, IL (US)

(73) Assignee: HONEYWELL INTERNATIONAL, INC. - PATENT SERVICES M/S AB/2B, Morristown, NJ (US)

(21) Appl. No.: 13/900,387

(22) Filed: May 22, 2013

(51) Int. Cl. B01J 20/06; B01D 53/86; B01D 53/04

(52) U.S. Cl. CPC B01J 20/06; B01D 53/0407; B01D 53/8678
USPC 252/190; 96/108; 96/154; 422/122

(57) ABSTRACT

A composition is provided for converting and removing undesirable gases from air comprising manganese dioxide, titanium dioxide and an alkali.

### BACKGROUND OF THE INVENTION

The present invention relates a higher capacity adsorbent for the removal of undesirable gases such as nitrogen oxides (NOx), sulfur oxides (SOx), hydrogen sulfide, hydrogen chloride, chlorine methyl bromine, and other acid gases or acid gas precursors. These contaminants may cause irritancy or toxicity in breathing air, corrosion in process equipment, defects in products, or environmental pollution.

In certain embodiments, the present invention relates to a composition, a filter and a system for removing nitric oxide (NO) and nitrogen dioxide (NO₂) from air.

Natural or processed air may contain undesirable gases such as nitrogen oxides (NOₓ), sulfur oxides (SOₓ), hydrogen sulfide, hydrogen chloride, chlorine methyl bromine, and other acid gases or acid gas precursors.

There exist solid adsorbents to remove acid gases from air, although NOₓ removal can be particularly challenging. In practice, the adsorbents can be non-regenerable and need to be disposed when their capacity has been reached. With these existing absorbents, the time between adsorbent changes can be increased by increasing the adsorbent size, although this may increase pressure drop, can be limited by the installation envelope, or may increase the installed weight, which can be prohibitive for mobile applications.

Therefore, there is a need to provide higher capacity absorbents with longer maintenance intervals and with the same size and weight of existing adsorbents.

### SUMMARY OF THE INVENTION

In one aspect of the present invention, a composition for converting and removing undesirable gases from air comprising manganese dioxide, titanium dioxide and an alkali is provided.

In another aspect of the present invention, a filter for converting and removing undesirable gases including a composition comprising manganese dioxide, titanium dioxide and an alkali is provided.

In a further aspect of the present invention, a system for treating air by converting and removing undesirable gases in the air is provided. The system comprises a filter including a composition comprising manganese dioxide, titanium dioxide and an alkali, a support structure for the filter; and an air conditioning system upstream from the support structure.

These and other features, aspects and advantages of the present invention will become better understood with reference to the following drawings, description and claims.

### BRIEF DESCRIPTION OF THE DRAWINGS

FIG. 1 is an illustration of a filter in accordance with an embodiment of the present invention.

FIG. 2 is an illustration of a first exemplary embodiment of an environmental control system including the filter of the present disclosure.

FIG. 3 is an illustration of a second embodiment of an environmental control system including the filter of the present disclosure.

### DETAILED DESCRIPTION

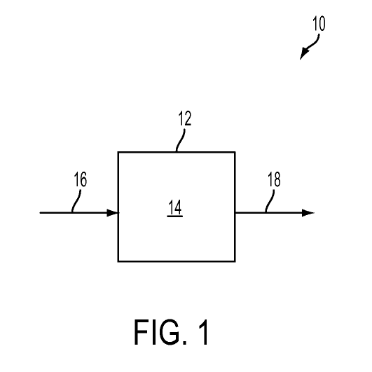

Referring to FIG. 1, a filter 10 including a vessel 12 containing filter material 14 is shown. During removal of undesirable gases in the air, an incoming stream 16 of air can be flowed over the filter material 14. The filter material 14 can reduce the levels of undesirable gases such as nitrogen oxides (NOx), sulfur oxides (SOx), hydrogen sulfide, hydrogen chloride, chlorine methyl bromine, and other acid gases or acid gas precursors in the air. Leaving the vessel 12 is a stream 18 of gas which may have reduced levels of the undesirable gases.

The filter material 14 may include a metal composition and an alkali. Their roles depend on mainly on the type, but also temperature and concentration of undesirable gas being removed. For example, the metal composition may convert the undesirable gases and the alkali may adsorb the converted undesirable gases by a chemical reaction, which for example, in the case of nitrogen oxides, may generate nitrate and/or nitrite on the alkali's exposed surface. In another example, the metal oxide may convert and adsorb certain undesirable gases and the alkali may adsorb certain other undesirable gases without the need for conversion by the metal oxide.

The metal composition may include manganese dioxide (MnO₂) and titanium dioxide (TiO₂). For example, the titanium dioxide pellets can be made of commercially available mixtures such as UOP's S-7001 Claus catalyst, or Degussa's P25 Titandioxid. The manganese dioxide can be made of commercially available mixtures such as “CARULITE 200” (available from Carus Chemical Co. located in Peru, Ill.) and “HOPCALITE” (available from Nacalai Tesque located in Kyoto, Japan). The “CARULITE 200” mixture may include about sixty to seventy five weight percent manganese dioxide (60 wt % to 75 wt % MnO₂), about eleven to fourteen weight percent copper oxide (11 wt % to 14 wt % CuO), and about fifteen to sixteen weight percent aluminum oxide (15 wt % to 16 wt % Al₂O₃). The “HOPCALITE” mixture may include sixty percent manganese dioxide (60 wt % MnO₂) and forty percent copper oxide (40 wt % CuO.

The ratio of manganese dioxide (or manganese dioxide-containing material) to titanium oxide in the metal composition can be, in one embodiment, from about 1:5 to about 5:1, or from about 1:1 to 4:1, or about 3:1.

The alkali can be potassium carbonate (K₂CO₃), potassium hydroxide (KOH) or another alkali or alkaline-earth carbonate or hydroxide. Other alkali can include, without limitation, carbonates of calcium (Ca), lithium (Li), sodium (Na), rhubidium (Rb), or cesium (Cs) can be used.

The titanium dioxide and manganese dioxide in the metal composition and the alkali can be combined in different ways.

In a first embodiment, a metal composition can be formed by wash-coating a titanium dioxide slurry onto a high geometric surface area such as a ceramic monolith (e.g. Celcor by Corning). For example, the titanium dioxide slurry can be formed by wet milling pellets of UOP's S-7001 Claus catalyst or Degussa's P25 Titandioxid. The titanium dioxide-washcoated monolith can be dried after each step. In another embodiment, titanium dioxide pellets can be used.

The manganese dioxide can be impregnated on the monolith wash coated with titanium dioxide or titanium dioxide pellets by contacting with an aqueous solution of manganese salt (e.g. manganese nitrate), drying, and calcining.

Potassium carbonate (K₂CO₃) can be combined with the manganese-impregnated titanium dioxide wash coated monoliths or pellets by impregnating with an aqueous solution of K₂CO₃. The impregnated particles can be dried in an inert gas atmosphere at a temperature about 100° C. Alternatively, the impregnated particle can be dried in air at a temperature of from about 300 to about 350° C.

In a second embodiment, a metal composition can be formed by combining titanium dioxide (e.g. UOP's S-7001 Claus catalyst, or Degussa's P25 Titandioxid powder). and manganese dioxide particles (e.g., “CARULITE 200” particles or “HOPCALITE” particles) and then impregnating the mixture with the alkali. The titanium dioxide and manganese oxide can be first mixed, then slurried and ball-milled, or ball-milled separately and then mixed. Ultimately, the resulting combination can be wash coated onto a substrate such as a ceramic monolith or metal substrate having a plurality of fins. The coated substrate can be impregnated with an aqueous solution of the alkali material. After drying, the impregnated coating may also be heat treated at a temperature above the expected operating temperature of the gas. If, however, the impregnated particles are dried at a temperature above the expected operating temperature of the air, the heat treatment step can be skipped.

Potassium carbonate (K₂CO₃) can be combined with the manganese dioxide particles and titanium dioxide pellets by impregnating with an aqueous solution of K₂CO₃. The impregnated particles can be dried in an inert atmosphere around 100° C. Alternatively, the impregnated particle can be dried in air at a temperature from about 300 to about 350° C.

In an embodiment, the filter material 14 can reduce the NOₓ level in gas having a temperature from about 15 to about 450° C. The optimal formulation of the filter material 14 can be temperature-dependent and specific to the composition of the titanium dioxide and manganese dioxide. In certain embodiments, a higher removal capacity can be obtained at a temperature from about 250 to 350° C.

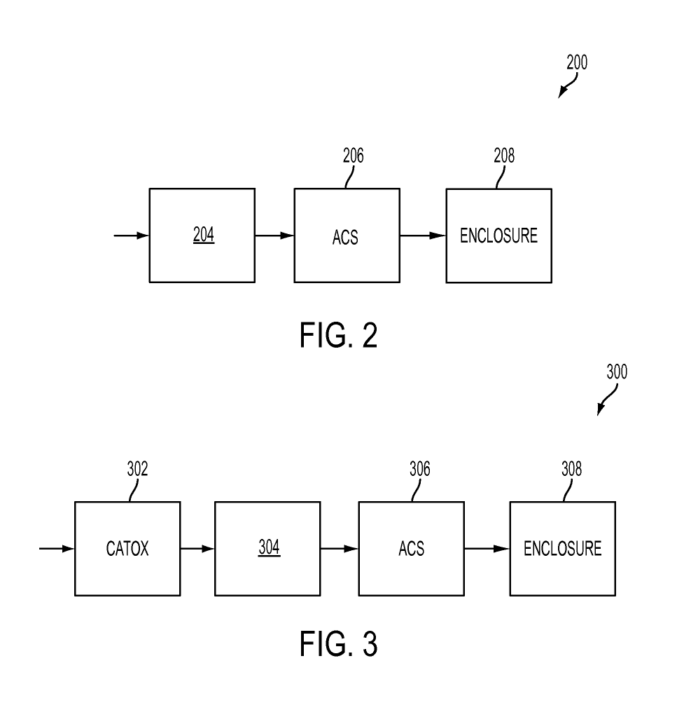

FIG. 2 shows an environmental control system (ECS) 200 for treating a stream of incoming air containing undesirable gases. The ECS 200 may include an air conditioning system (ACS) 206 for cooling and conditioning the air. The ECS 200 may further include a filter 204 upstream from the air conditioning system (ACS).

Air leaving the filter 204 can be supplied to an air conditioning system (ACS) 206 for cooling and conditioning the air. The treated air can be supplied to an enclosure 208 (e.g., a crew compartment of a vehicle) or may vented to the atmosphere.

In one embodiment, the filter 204 may reduce the level of NOₓ in the air. The filter 204 can be operated at a residence time of 0.03 to 1 second and at a temperature in the range of from about 15 to 450° C. or at a temperature of from about 200 to 450° C. or at a temperature from about 250 to 350° C. in embodiments where the air can be heated to such temperature.

FIG. 3 shows an environmental control system 300 including a filter 304 as described above in connection with FIG. 1. The ECS 300 may include a catalytic oxidation reactor (CATOX) 302 for oxidizing organic compounds to carbon dioxide and water. Heteroatoms such as sulfur, nitrogen, phosphorus, chlorine, and fluorine form additional byproducts such as acid gases or precursors. For example, air leaving the CATOX 302 may include undesirable gases.

Air leaving the filter 304 can be supplied to an air conditioning system (ACS) 306 for cooling and conditioning the air. The treated air can be supplied to an enclosure 308 (e.g., a crew compartment of a vehicle) or may vented to the atmosphere.

In one embodiment, for the removal of NOₓ in the air, the CATOX 302 and the filter 304 can be operated at residence times of 0.1 to 1.0 seconds and at a temperature in the range of from about 15 to 450° C. or at a temperature of from about 200 to 450° C. or at a temperature from about 250 to 350° C. in embodiments where the air can be heated to such temperature.

The filters according to the present disclosure are not limited to environmental control systems. The filters can be used for the removal of unwanted gases, including without limitation, NOₓ from breathable air, the removal of NOₓ from combustion engine exhaust; the removal of NOₓ from gas streams generated by coal and residual oil burning furnaces; the removal of NOₓ from catalytic oxidizers and non-catalytic thermal oxidizers that process nitrogen-containing organic molecules such as amines; the removal of NOₓ from nitric acid production plants; and the removal of NOₓ from nitrite production plants.

Design considerations such as adsorbent size, gas flow rate, and desired unwanted gas levels in the effluent gas will depend upon the application for which the conversion of the undesirable gas is intended. Undesirable gases include without limitation chlorine-containing compounds such as chlorine gas and hydrogen chloride, fluorine-containing compounds such as hydrogen fluoride, bromine-containing compounds such as bromomethane, sulfur-containing compounds such as sulfur dioxide, and nitrogen-containing compounds such as ammonia and cyanogen chloride.

Specific embodiments may now be described in detail. These examples are intended to be illustrative, and the invention is not limited to the materials, conditions, or process parameters set forth in these embodiments. All parts and percentages are by weight unless otherwise indicated.

### EXAMPLES

### Example 1

In this Example, a NOₓ scrubber comprised of titanium dioxide, manganese dioxide and potassium carbonate was prepared according to the first embodiment. In this method, the following proportions were used:

| | |
|---|---|
| Monolith | 230 g |
| TiO₂-Ceria WC | 110 g |
| MnO₂ | 4.5 g |
| K₂CO₃ | 32 g |
| Total | 376.5 g |

A 900 cpi cordierite monolith was wash coated in 3 passes with a titanium dioxide-ceria slurry to achieve a loading of 2.2 g of dry washcoat per cubic inch or about 110 g of washcoat on the part. The part was calcined between passes. This part was then cooled, and dipped in a 26% solution of manganese nitrate with a pick-up after air-knifing of 60 g of solution. The part was then calcined to convert the manganese nitrate to the oxide. The pick-up of manganese nitrate was 15 g, but is converted to about 4.5 g of manganese dioxide on the part. The part was cooled and then dipped in a 30% solution of potassium carbonate with a pick up after air-knifing of about 10 g of solution. The part was then air dried at 200° C. for 1 hour with a dry weight pick up of potassium carbonate of 32 g.

### Example 2

In this Example, a part was prepared according to the second embodiment. A slurry of MnO₂/titania was prepared in the following proportions:

| | |
|---|---|
| Monolith | 230 g |
| Carulite/Titania | 110 g |
| K₂CO₃ | 32 g |
| Total | 372 g |

A part is wash coated with a 50:50 of Carulite 200:titania-ceria slurry and then impregnated with K₂CO₃. A 900 cpi cordierite monolith was wash coated with a slurry composed of 1 part 33% Carulite in water and 1 part 33% titania-ceria in water. Both were ball milled prior to use to create a small particle slurry. The part was wash coated in three passes to achieve a loading of 2.2 g of dry wash coat per cubic inch or about 110 g of wash coat on the part. The part was calcined between passes.

After calcining the final time, the part was dipped in a 30% K₂CO₃ solution with a pick-up after air-knifing of about 110 g of solution. After air drying at 200° C. for 1 hour the dry weight pick up was about 32 g of potassium carbonate.

### Example 3

### Composition #1

In this Example, commercially available S-7001 titanium dioxide pellets were ball-milled in a slurry and combined with a slurry of commercially available (“CARULITE 200”) manganese dioxide. Various ratios of titanium dioxide and manganese oxide were prepared. Each of these combined slurries was washcoated onto ceramic monoliths. The wash coated monolith was dried and heated in air. In contrast with Compositions #2 and #4 (Examples 4 and 5), manganese dioxide particles were not impregnated into the wash coated high-surface titanium dioxide surface, but instead, the manganese dioxide was part of the washcoat onto which potassium was impregnated. The following compositions were prepared:

| Composition #1 | Magnesium Dioxide (%) | Titanium Dioxide (%) |
|---|---|---|
| A | 0 | 100 |
| B | 25 | 75 |
| C | 50 | 50 |
| D | 75 | 25 |
| E | 100 | 0 |

### Example 4

### Composition #2

In this Example, a monolith is washcoated with an aqueous slurry prepared from ball-milling commercially available titanium dioxide pellets. The thus coated monolith is impregnated with a 30% aqueous solution of manganese nitrate. The impregnated and wash coated monolith is dried and calcined. Then, potassium carbonate (K₂CO₃) is combined with the thus impregnated and wash coated monolith by impregnating with a 30% aqueous solution of K₂CO₃. The resulting coated monolith is dried and calcined.

### Example 5

### Composition #3

In this Example, a filter was prepared as in Example #1, with the difference that the heating step after impregnation with potassium carbonate (K₂CO₃) was conducted in an inert gas furnace instead of combustion furnace.

### Example 6

### Composition #4

In this Example, potassium carbonate (K₂CO₃) can be combined with “CARULITE 200” particles by impregnating 100 grams of commercially available “CARULITE 200” particles with 70 mL of an aqueous solution of K2CO3 containing 11 grams of K₂CO₃. The impregnated particles are then dried in a rotary impregnator at a temperature of 100° C. Both the “CARULITE 200” particles (prior to impregnation) and the dried particles (after impregnation) are sieved to 20-35 Tyler mesh.

### Example 7

### Composition #5

In this Example, pellets of gamma-aluminum oxide were impregnated with an aqueous solution of calcium nitrate, dried, and calcined so that the resulting loading of calcium oxide was 10%.

### Example 8

In this Example, a gas mixture was prepared by blending a compressed gas cylinder of sulfur dioxide (SO₂) in air with house air to reach an SO₂ concentration of 400 ppm. The gas volumetric flow rate was set as a ratio of the filter volume; when this ratio is expressed in units of inverse hours (hr⁻¹), the ratio is named Gas Hourly Space Velocity (GHSV).

Table 1 shows the increased capacity of the filter comprising Composition #4 as compared to Composition #1 for nitrogen oxides (NOₓ) in air.

TABLE 1

| | mg | | | |
|---|---|---|---|---|
| g NOₓ/ | NOₓ/g | | NOₓ Concentration | |
| in³ | Filter | Filter Description | (ppm) | GHSV |
| 0.00 | 0 | Composition #5 | 400 | |
| 0.53 | 22 | Composition #4 | 760 | 21,000 |
| 0.26 | 32 | Composition #1 | 400-800 | 15000-21000 |
| 0.34 | 42 | Composition #3 | 575 | 15300 |

In Table 2, the GHSV was 15,000 to 21,000 hr⁻¹. The capacity is defined as the amount of SO₂ that is removed by the filter until breakthrough is reached (i.e. when the effluent concentration reaches a predetermined level, such as 3 ppm). In this case, the capacity is normalized to volume of filter and has units of g SO₂/in³ filter.

Table 2 demonstrates that at an SO₂ concentration of 400 ppm there is an increase in SO₂ capacity of a filter comprising Composition #1 and Composition #3 as compared to a filter comprising Composition #4.

TABLE 2

| Capacity | | |
|---|---|---|
| (g SO₂/in³) | Description | GHSV |
| 0.24 | Composition #4 | 16.667 |
| 0.19 | Composition #2 | 21,100 |
| 0.27 | Composition #3 | 15,300 |
| 0.46 | Composition #1 | 15,300 |

### Example 9

To optimize the performance of Composition #1, the ratio of titanium dioxide and manganese dioxide were varied from about 25%/75% to 0%/100% as described in Example 3 and tested against sulfur dioxide (SO₂) and hydrochloric acid (HCl).

In this Example, 18 liters per minute of a blend of SO₂ in air (concentration 1,000 mg SO₂/m³ air) was flowed through a monolith sample with dimension 1.35″ outside diameter by 3″ long. At a temperature of 295° C., the breakthrough time was measured. Results are presented in Table 3. A similar set of experiments was conducted with HCl in air; those results are in Table 4.

Tables 3 and 4 indicate that Composition #1 with a ratio of titanium dioxide/manganese dioxide of about 25/75 was optimum for these tests.

TABLE 3

| Composition #1 | Breakthrough Time (min) |
|---|---|
| A | 52 |
| B | 41 |
| C | 68 |
| D | 73 |
| E | 42 |

TABLE 4

| Composition #1 | Breakthrough Time (min) |
|---|---|
| A | 31 |
| C | 45 |
| D | 49 |

### Example 10

In this Example, the capacity of the 75% manganese/25% titania wash coat was measured as a function of GHSV and concentration. Three different flow rates were used 16 ft³/min (cfm), 1 cfm, and 0.3 cfm to show that there was no scaling bias in the test hardware. The monolith volume was varied to achieve the desired GHSV.

The capacity of this formulation of Composition #1 exceeded that of Composition #5. A comparison is made in Table 5 (the model prediction for Composition #5 is based on data collected at similar conditions).

TABLE 5

| | | | | Composition | | | |
|---|---|---|---|---|---|---|---|
| | | Temper- | Concen- | #5 Model | | | |
| Flow | | ature | tration | Prediction | g | Composition | g |
| CFM | GHSV | (° C.) | (mg/m³) | (min) | HCl/in³ | #1 | HCl/in³ |
| 16 | 8015 | 285 | 1,961 | 50 | 0.216 | 142 | 0.610 |
| 16 | 8015 | 285 | 9,162 | | | 56 | 1.193 |
| 1 | 7807 | 294 | 14,315 | | | 42 | 1.281 |
| 1 | 7807 | 285 | 6,920 | 11.0 | 0.162 | 100 | 1.475 |
| 0.3 | 8119 | 292 | 922.5 | 114.5 | 0.234 | 250 | 0.508 |
| 0.3 | 8119 | 292 | 4094 | 25 | 0.227 | 66.5 | 0.602 |
| 0.3 | 8119 | 292 | 9927 | | | 60 | 1.320 |
| 0.3 | 12178 | 292 | 908 | 70.3 | 0.211 | 229.5 | 0.700 |
| 0.3 | 12178 | 292 | 3881 | 16.0 | 0.206 | 60 | 0.774 |
| 0.3 | 12178 | 292 | 10020 | | | 17 | 0.566 |
| 0.3 | 18267 | 292 | 773 | 49.8 | 0.192 | 113 | 0.436 |
| 0.3 | 18267 | 292 | 1000 | 38.0 | 0.189 | 103 | 0.514 |
| 0.3 | 18267 | 292 | 3807 | 9.6 | 0.182 | 28 | 0.531 |
| 0.3 | 18267 | 292 | 10748 | | | 11 | 0.589 |

### Example 11

In this Example, the capacity of the 75% manganese dioxide/25% titanium dioxide wash coat was measured as a function of GHSV and concentration. Three different flow rates were used 16 ft³/min (cfm), 1 cfm, and 0.3 cfm to show there was no scaling bias in the test hardware. The monolith volume was varied to achieve the desired GHSV.

Table 6 shows a comparison of the SO₂ capacity of composition #1 with composition #1 at a range of concentrations and space velocities. Similar to the initial results in Table 2, the capacity for composition #1 is typically twice that of composition #1.

TABLE 6

| | | | | Composition | Capacity of | Composition | |
|---|---|---|---|---|---|---|---|
| | | Temper- | Concen- | #2 Model | Composition | #1 Actual | Capacity of |
| Flow | | ature | tration | Prediction | #2 | Data | Composition #1 |
| (CFM) | GHSV | (° C.) | (mg/m³) | (minutes) | (g SO₂/in³) | (minutes) | (g/SO₂/in³) |
| 16 | 8015 | 285 | 1979 | 53.6 | 0.232 | 134.5 | 0.583 |
| 16 | 8015 | 285 | 7355 | 14.4 | 0.232 | 29 | 0.467 |
| 16 | 8015 | 285 | 10177 | 10.6 | 0.236 | 27 | 0.601 |
| 0.3 | 8119 | 292 | 4450 | 28.8 | 0.284 | 98 | 0.966 |
| 0.3 | 8119 | 292 | 1013 | 112.6 | 0.253 | 239 | 0.537 |
| 0.3 | 8119 | 292 | 9874 | 11.4 | 0.249 | 36 | 0.788 |
| 0.3 | 8119 | 292 | 4450 | 25.4 | 0.250 | 100 | 0.986 |
| 0.3 | 12,178 | 292 | 1021 | 72 | 0.244 | 186 | 0.631 |
| 0.3 | 12,178 | 292 | 4031 | 18.0 | 0.241 | 39 | 0.523 |
| 0.3 | 12,178 | 292 | 9874 | 7.4 | 0.243 | 23 | 0.755 |
| 0.3 | 18,267 | 292 | 4141 | 12.0 | 0.248 | 20 | 0.413 |
| 0.3 | 18,267 | 292 | 9554 | 5.2 | 0.248 | 6 | 0.286 |
| 0.3 | 18,267 | 292 | 952 | 51.7 | 0.245 | 69 | 0.326 |

### Example 12

Table 7 shows that composition #1, while improving the SO₂ and HCl capacity, has maintained the improvements in NOx capacity shown by Composition #1, which is greater than Composition #4.

TABLE 7

| | | NOₓ | Composition | Composition | Composition | |
|---|---|---|---|---|---|---|
| | Temper- | Concen- | #1 Model | #1 | #2 Actual | Composition |
| Flow | ature | tration | Prediction | Capacity | Data | #2 Capacity |
| (CFM) | (° C.) | mg/m³ | (minutes) | (g NOₓ/in³) | (minutes) | (g NOₓ/in³) |
| 16 | 285 | 482 | 354 | 0.371 | 323 | 0.338 |
| 16 | 285 | 962 | 173 | 0.361 | 175 | 0.366 |
| 16 | 285 | 1925 | 84 | 0.352 | 72 | 0.301 |
| 16 | 285 | 8639 | 18 | 0.334 | 17 | 0.312 |

The present invention is not limited to the specific embodiments described above. Instead, the present invention is construed according to the claims that follow. It should be understood, of course, that the foregoing relates to exemplary embodiments of the invention and that modifications can be made without departing from the spirit and scope of the invention as set forth in the following claims.

What is claimed is:

1. A composition for converting and removing undesirable gases from air comprising manganese dioxide, titanium dioxide and an alkali.

2. The composition of claim 1, wherein the ratio of manganese dioxide to titanium dioxide is from about 1.5 to about 5.1.

3. The composition of claim 2, wherein the alkali includes potassium.

4. The composition of claim 3, wherein the titanium dioxide is washcoated onto a high geometric surface area and the manganese dioxide is impregnated on the washcoated titanium dioxide to form a substrate.

5. The composition of claim 4, wherein the substrate is impregnated with the alkali.

6. The composition of claim 3, wherein the manganese dioxide and the titanium dioxide are mixed and the mixture is washcoated on a substrate.

7. The composition of claim 6, wherein the substrate is impregnated with the alkali.

8. A filter for converting and removing undesirable gases including a composition comprising manganese dioxide, titanium dioxide and an alkali.

9. The filter of claim 8, wherein the ratio of manganese dioxide to titanium dioxide is from about 1.5 to about 5.1.

10. The filter of claim 9, wherein the alkali includes potassium.

11. The filter of claim 8, wherein the undesirable gas is NO, and the converted gas is NO₂.

12. The filter of claim 11, wherein the filter is operated at a temperature of from about 250 to about 450° C.

13. A system for treating air by converting and removing undesirable gases in the air, the system comprising:
a filter including a composition comprising manganese dioxide, titanium dioxide and an alkali;
a support structure for the filter; and
an air conditioning system upstream from the support structure.

14. The system of claim 13, further comprising an enclosure upstream from the support structure for storing the treated air.

15. The system of claim 13, wherein the undesirable gas is NO, and the converted gas is NO₂.

16. The system of claim 15, wherein the filter is operated at a residence time of 0.03 to 1 second and a temperature of from about 200 to about 450° C.

17. The system of claim 13, further comprising a CATOX downstream from the support structure for converting organic acids to carbon dioxide and water.

18. The system of claim 17, wherein the filter and the CATOX are operated at a residence time of 0.1 to 1 seconds and at a temperature of from about 200 to about 450° C.

19. The system of claim 13, wherein the ratio of manganese dioxide to titanium dioxide is from about 1.5 to about 5.1.

20. The system of claim 13, wherein the alkali includes potassium.
